(19) United States
(12) Patent Application Publication
(10) Pub. No.: US 2010/0148533 A1
(43) Pub. Date: Jun. 17, 2010

(54) Cabriolet

(76) Inventor: Nils Kreiling, Osnabruck (DE)

Correspondence Address: QUINN LAW GROUP, PLLC, 39555 ORCHARD HILL PLACE, SUITE # 520, NOVI, MI, 48375, US

(21) Appl. No.: 10/597,101

(22) PCT Filed: Jan. 15, 2005
(86) PCT No.: PCT/DE05/00054

§ 371 Date: May 30, 2007

(30) Foreign Application Priority Data
Jan. 20, 2004 (DE) 10 2004 003 021.9

(51) Int. Cl. B60J 7/00

(52) U.S. Cl. 296/107.16

(57) ABSTRACT

A cabriolet vehicle (1) is provided with a roof (3) which at least in some areas has a flexible cover (6), which includes in its front roof area (7) a rigid end area (8), a so-called roof top, overlapped by a cover (6), in which the front roof area (7) can be stored in the same orientation as in the closed roof state in or partially above a body recess (9), which is bounded at least rearward by an edge (11) of auto body (4). The front roof area (7) is variable in length by at least one additional support (14) that supports roof area (6) from below, and can be displaced in the vehicle longitudinal direction.

### CROSS-REFERENCE TO RELATED APPLICATION(S)

This application is a US National Phase of International Application No. PCT/DE 2005/000054, filed Jan. 15, 2005, which claims priority to German 10 2004 003 021.9, filed Jan. 20, 2004. The entire contents of the above identified applications are incorporated herein by reference.

### TECHNICAL FIELD

The invention relates to a cabriolet vehicle with a roof, which at least in some areas has a flexible cover, according to the preamble of claim 1.

### BACKGROUND OF THE INVENTION

It is known that the front roof area in a cabriolet vehicle of the mentioned type, when the roof is opened, lies with its rigid roof top over other areas of the roof in the fashion of a cover and remains openly visible from the top at least for the most part. The roof then lies in an auto body recess made in the outside surface of the auto body. It encloses the recess at least on the sides and rear. In the front it is indirectly or often directly connected to a passenger compartment.

In this case, on the one hand the rear limitation of the recess, which represents a front edge of the body outside surface connected farther rearward is designed in a curved shape, which runs forward to the vehicle sides, for a harmonic transition of the edges bordering the recess. Functionally this is also desirable for the largest possible access opening beneath a trunk lid adjacent to the rear, which is supposed to lie with its front limitation edge in the direction of travel parallel to the front edge that borders the recess.

On the other hand, a roof of the mentioned type, when opened, is supposed to fold in behind the rigidly held from below front roof area so that the folding edge there, if possible, runs at least almost linearly in a 90° angle relative to the direction of travel over the roof width in a top view in order to ensure a clean cover trend when the roof is closed without additional areas of loose fabric or folds.

Consequently, a conflict arises on the rear edge of the limitation of the recess at least in the side corner areas between the linear rear edge of the front roof part, which then lies on the top, and the limitation edge of the recess, which points forward on the transverse sides. If the corners of the front roof part during roof movement are supposed to be passed by the edge without collision, a significant spacing between the parts is therefore essential. Consequently, an elongated gap between the edge of the recess and the folding edge of the front roof part positioned to the rear remains at least in the area of the vertical vehicle longitudinal center plane in the vehicle longitudinal direction. Such gaps, however, are optically undesirable and without additional measures also make possible unauthorized access into the trunk situated beneath it.

An attempt to mitigate this conflict consists of providing for the rear end area of the recess a narrow moving hinged cover almost crescent-shaped in top view, whose rear edge lies essentially across the vehicle and whose front edge exhibits the desired curvature with the forward facing transverse edge areas. This moving cover, however, requires additional drive and control expense and with its additional side joints interferes with the appearance of the outer surface of the auto body.

### SUMMARY OF THE INVENTION

The underlying problem solved by the invention is to optimize storage of a roof with the front roof part lying in the same orientation in the stored position as in the closed position.

The invention solves this problem through a cabriolet vehicle with the features of claim 1. With respect to additional advantageous embodiments of the invention, claims 2 to 12 are referred to.

A situation is achieved with the design according to the invention in that the longitudinal extent of the front roof area is variable by length variation of rigid parts supporting the cover from below and therefore the front roof area can be shorter during movement than in the opened position. The roof area can therefore be passed by the edge bordering the body recess in the shortened position and then extended again beneath it to greater length. The passage space of the roof through the outside surface of the body can therefore be kept very small and therefore need not be increased by a hinged cover or the like.

When the edge adjacent to the body recess in the open position of the roof is held from below at least in the outer vehicle transverse areas by the additional support with the cover overlapping it, the recess of the body can be kept very short, which is an advantage for the trunk and the proportions. However, if necessary, a transverse support on the upper vehicle outside surface, which stabilizes the body, can be allocated to a front trunk edge.

The control expense for length variability of the front roof part is minimized, if movement of the additional support can be controlled as a function of the corresponding state of movement of the roof. In particular, the additional support that produces lengthening can be controllable via a closure that produces locking of the roof onto a windshield frame. With opening of the closure (manual or driven) the additional support then simultaneously travels forward so that the shortening of the front roof area necessary for the final phase of the opening movement is established. In the stored position the closure can then also be acted upon via a corresponding counterpart of the body so that the lengthening of the roof area beneath the limiting body edge is established.

The additional support can further improve the cover trend by spanning the cover, in particular when the support extends across the direction of travel, and is designed in the fashion of a convertible top bow that holds the cover from below over its entire width.

Additional advantages and features of the invention are apparent from a practical example of the object of the invention schematically depicted in the drawing and described below.

### BRIEF DESCRIPTION OF THE DRAWINGS

In the drawings:

FIG. 1 shows a vehicle according to the invention in a schematic view truncated on the vertical longitudinal center plane from the top with the roof opened,

FIG. 2 shows a view similar to FIG. 1 but with the roof closed,

FIG. 3 shows a vehicle according to the prior art in a view similar to that of FIG. 1,

FIG. 4 shows a schematized side section truncated in the lower portion in the area of the vertical longitudinal center plane of the vehicle according to the invention with the roof closed and locked,

FIG. 5 shows a view similar to that of FIG. 4, with a still closed but already unlocked roof with the additional support displaced forward,

FIG. 6 shows a detailed section roughly corresponding to section VI of FIG. 5, but with the roof open and the additional support still displaced forward,

FIG. 7 shows a view similar to that of FIG. 6 with the roof opened and the additional support displaced rearward,

FIG. 8 shows a view similar to that of FIG. 4 but without the roof cover shown,

FIG. 9 shows a view similar to that of FIG. 5 but without the roof cover shown,

FIG. 10 shows a view similar to that of FIG. 6 but without the roof cover shown.

FIG. 11 shows a view similar to that of FIG. 7 but without the roof cover shown,

FIG. 12 shows a top view of the rear area in the roof position according to FIG. 10,

FIG. 13 shows a view similar to that of FIG. 12 in the roof position according to FIG. 11,

FIG. 14 shows a perspective view obliquely from the front, with the cover assumed transparent, onto the left front corner of the roof top with the additional support displaced rearward,

FIG. 15 shows the parts according to FIG. 14 in a top view,

FIG. 16 shows the parts according to FIG. 14 in a view obliquely from the rear.

### DESCRIPTION OF THE PREFERRED EMBODIMENTS

A two-seat vehicle 1 is depicted in the drawing figures. The invention is naturally just as applicable to a four- or multi-seat cabriolet vehicle provided with a rear seat.

The vehicle 1 has in its upper area a roof 3 movable relative to auto body 4 and indirectly or directly adjacent to a windshield frame 2, which can include a flexible roof cover 6 outside a rear window 5.

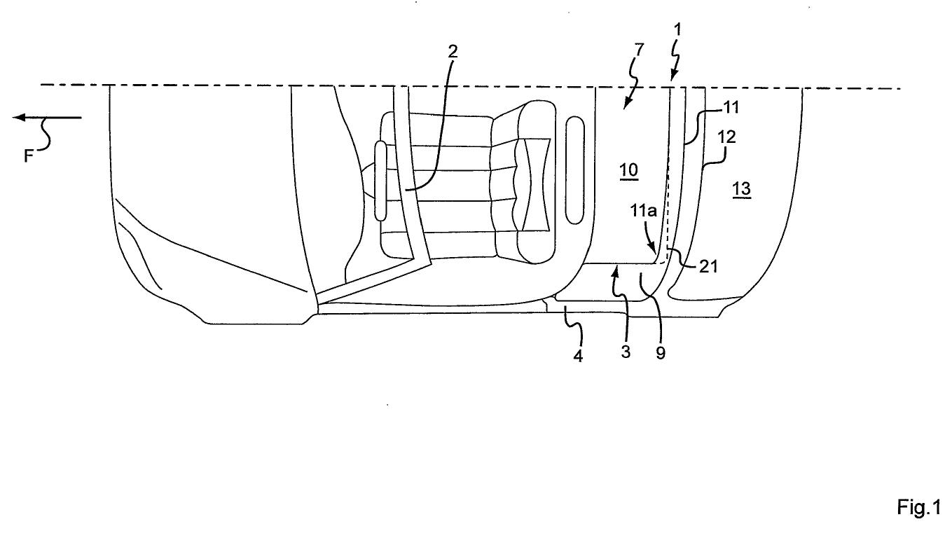

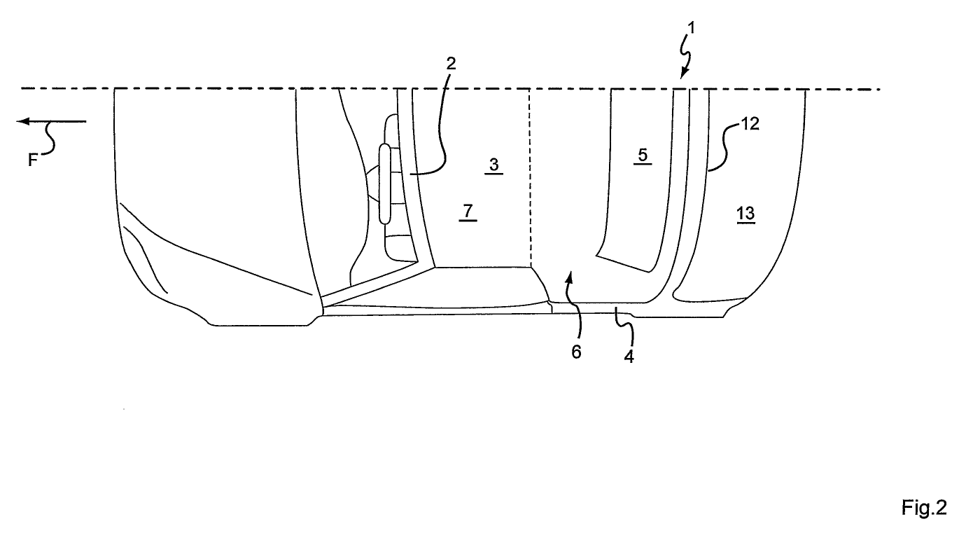

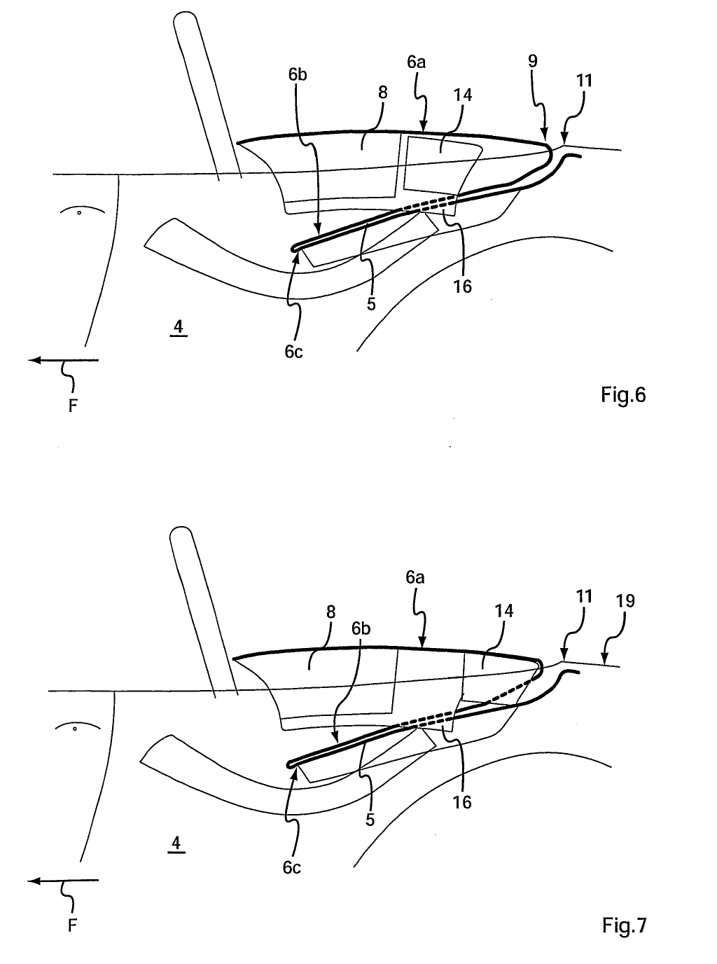

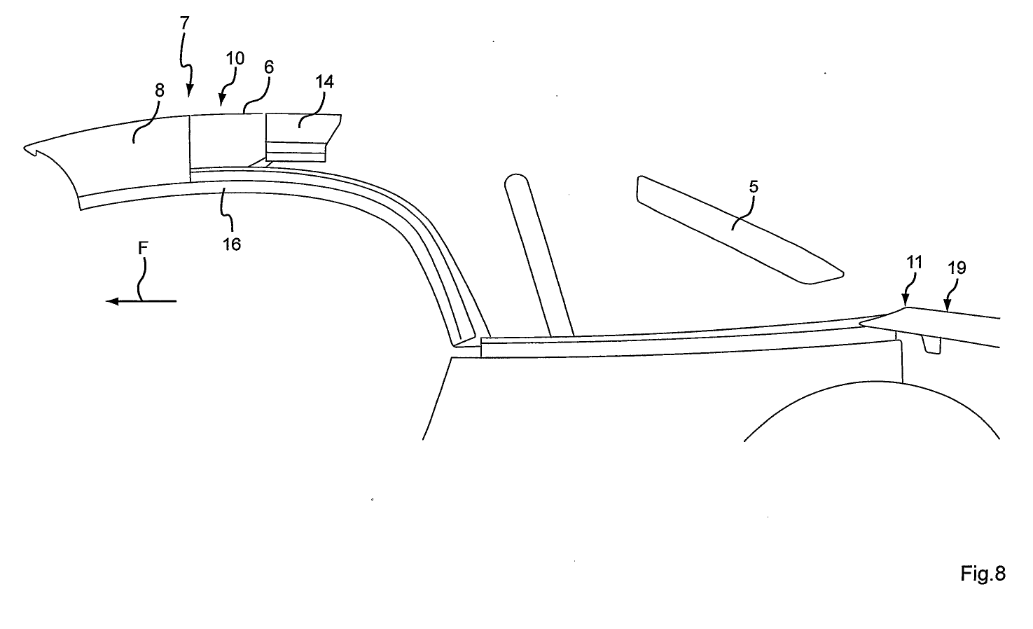

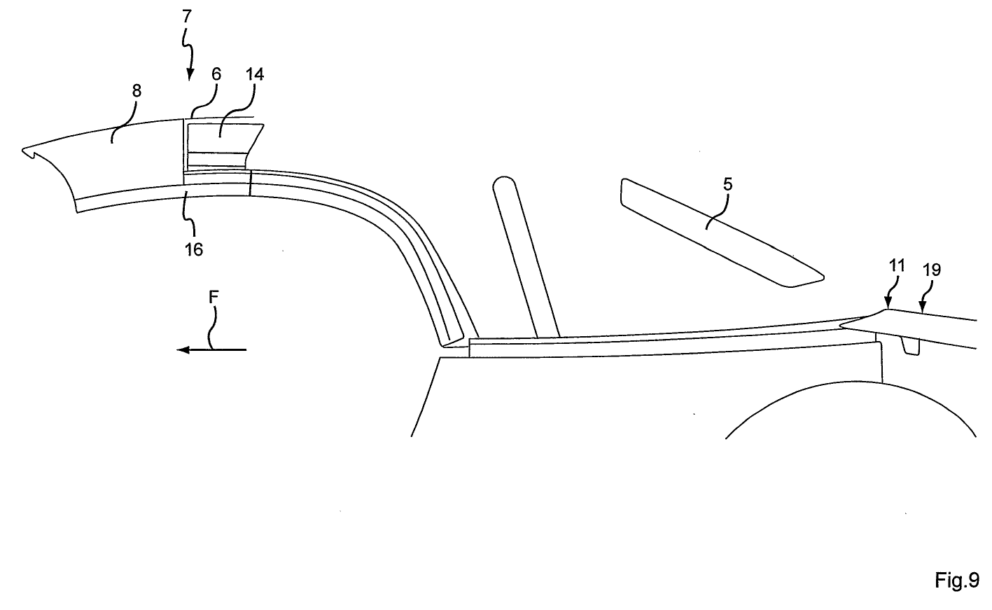

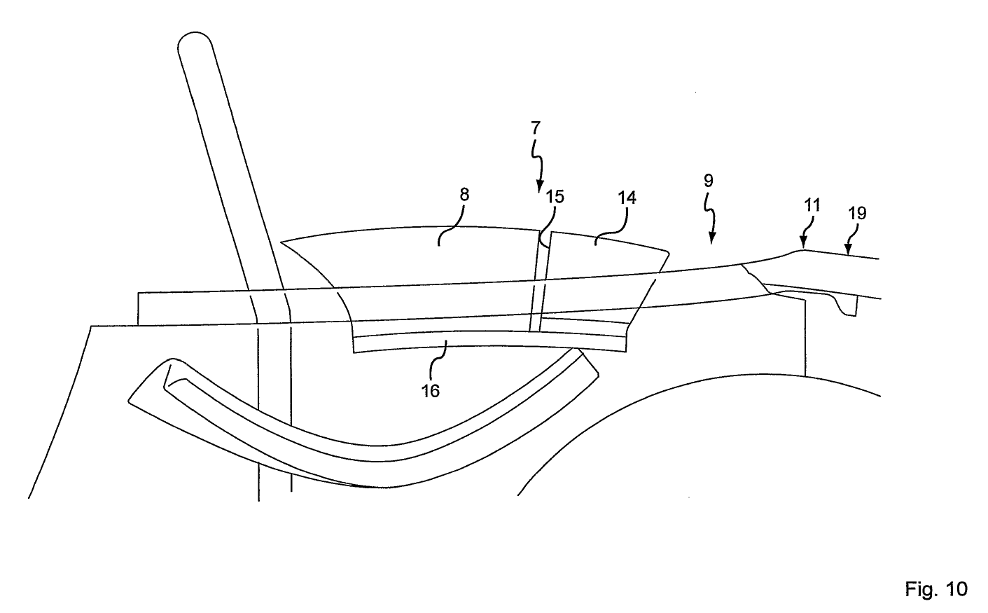

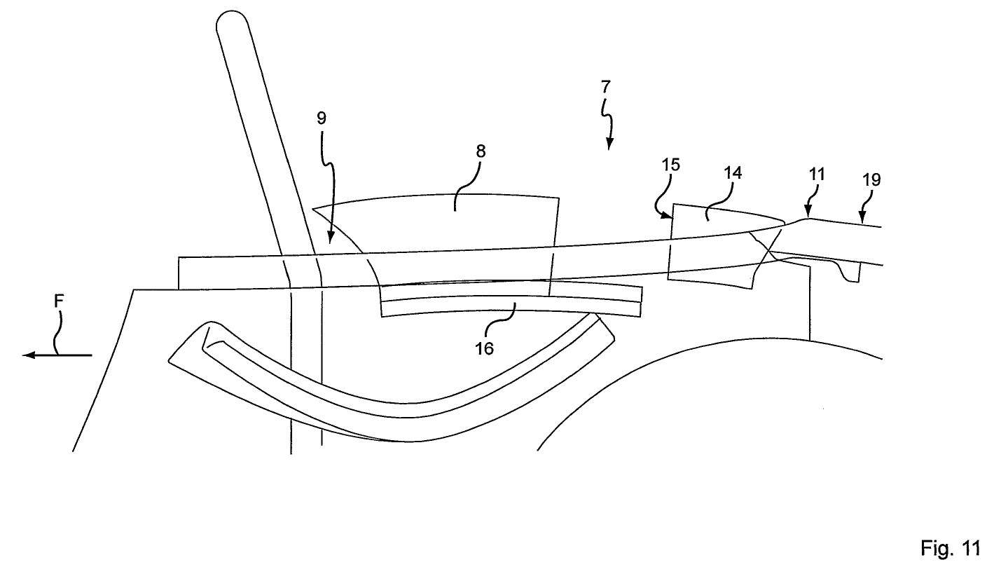

The roof 3 in the direction of travel F contains a front roof area 7, which comprises a rigid end area 8, so called roof top, at least partially overlapped by cover 6. The front roof area 7, during opening of the roof (transition from FIG. 2 to FIG. 1) can be stored in the same orientation as in the closed state in a body recess 9, i.e., the surface 10 of the front roof area 7, facing upward and outward with the roof 3 closed, also faces upward in the opened state of roof 3. Roof 3 for this purpose can be storable in a so-called Z-fold, in which the cover 6, is stored in the shape of a Z, with an upper section 6a stored above the roof top 8, and the lower section 6c stored around the rear window 5, and an intermediate section 6b that diagonally connects them (FIG. 6, FIG. 7).

The body recess 9 used to accommodate the opened roof 3 is bounded on the back and partly on the sides by an edge 11 of the body. This edge 11 is bent overall so that its side sections 11a includes a component pointing in direction of travel F. It therefore lies parallel to a front closure edge 12 of a trunk lid 13, and can be formed by said edge itself.

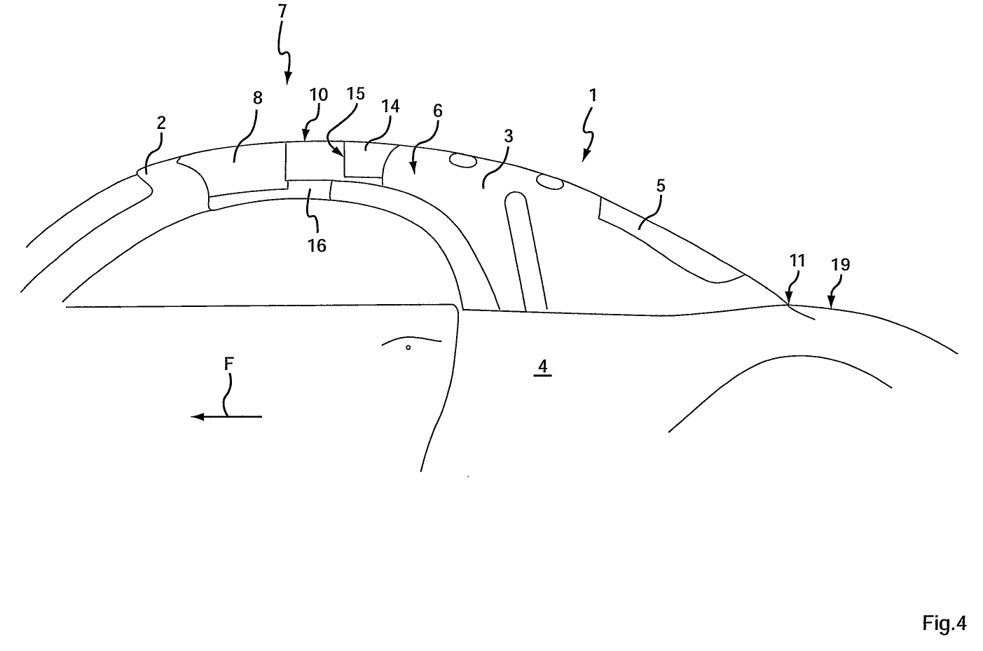

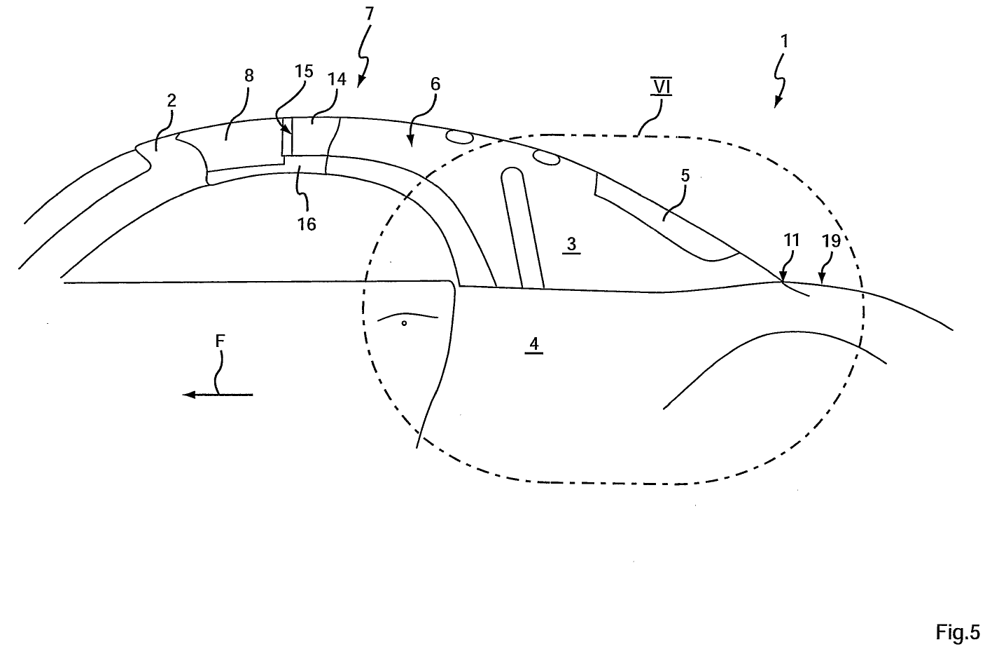

The front roof area 7 also includes a longitudinally displaceable additional support 14, which can be arranged beneath cover 6 and is movable relative to it. By means of additional support 14, the front roof area 7 is variable in length between the lengthened position depicted in FIG. 4 and the shortened position depicted in FIG. 5. The additional support 14 extends across direction of travel F over the entire width of cover 6 and can support it in the fashion of a convertible top bow, which, especially in the closed state of roof 3 (FIG. 4) can ensure a tightened and almost kink-free straight trend.

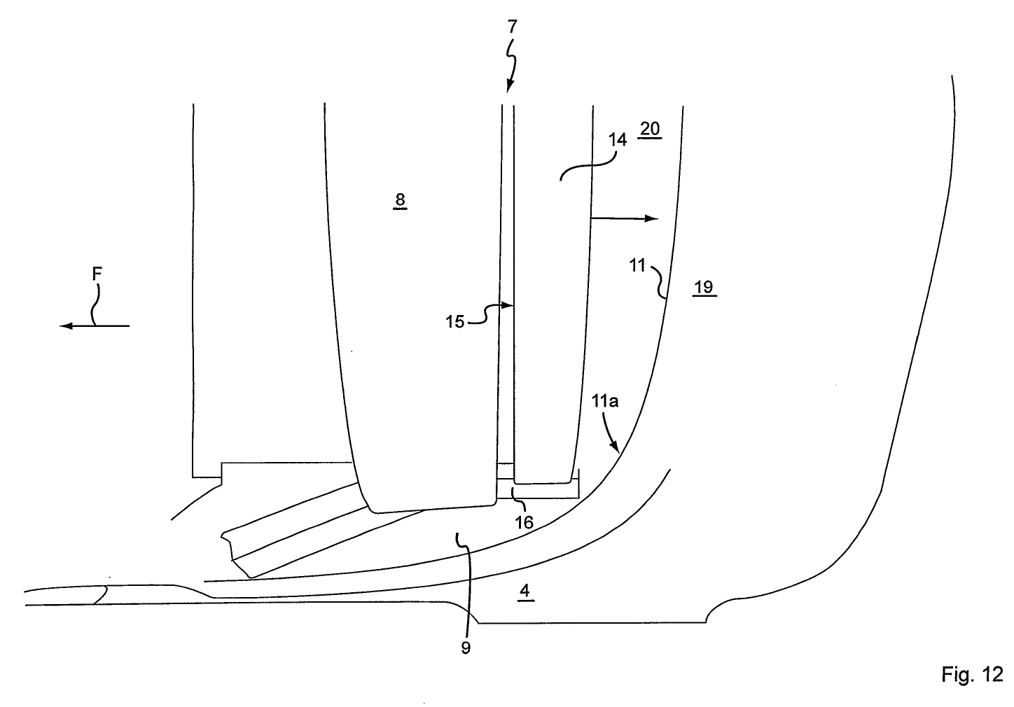

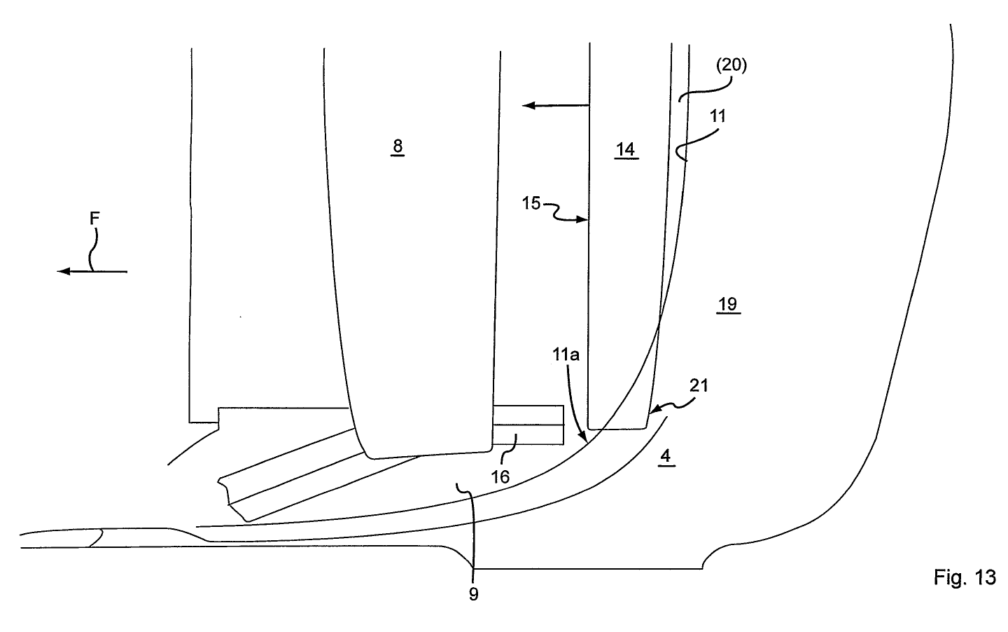

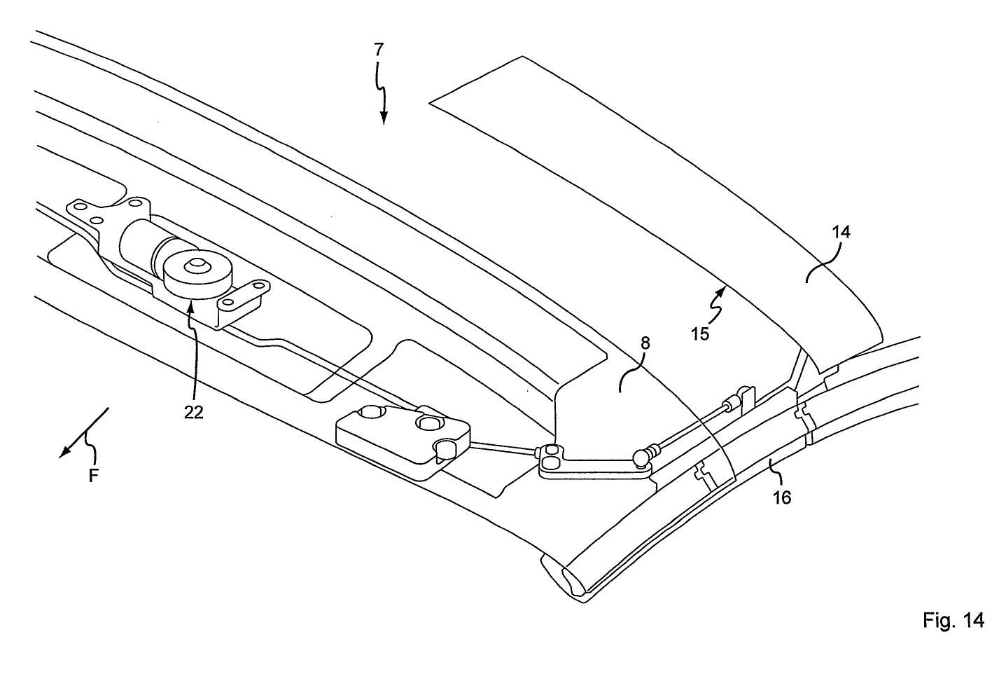

The additional support 14 in a top view includes a wider rectangular surface relative to a convertible top bow (see for example FIG. 12) and with its front edge 15 can be connected flush with the roof top 8 so that together the two form a rigid support surface for cover 6. The rear edge of the additional support 14 can optionally be slightly adjusted to the trend of edge 11.

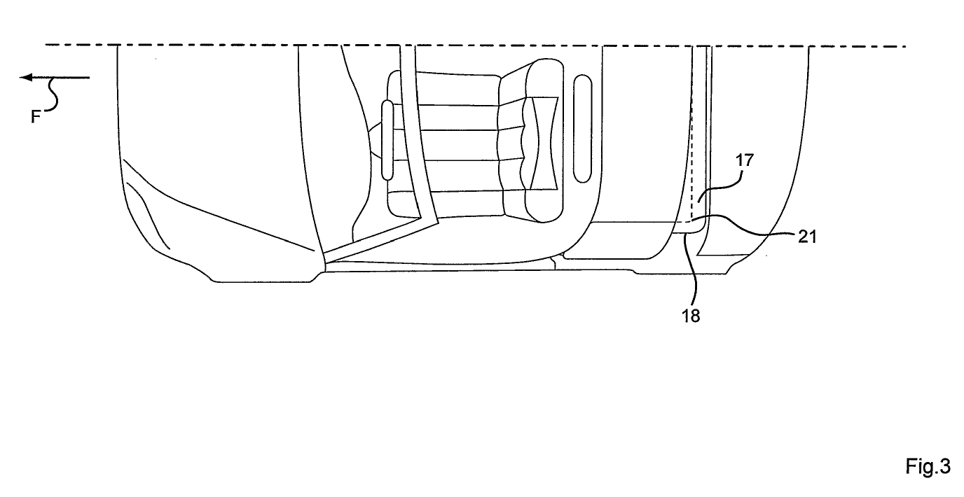

In the closed roof position (FIG. 4) the additional support 14 is in its rearward deployed position, in which it lengthens the front roof area 7 by the extent of the front side frame 16, that is rigidly connected to the roof top 8, so that the positive effect of the cover trend outlined above is produced. If one intends to open the roof 3 in this position and lower it into recess 9, however, the limitation edge 11 must be displaced very far rearward or, as shown in FIG. 3, an additional hinge cover 17 must be provided, which can open for passage of roof 3 and therefore avoid collision of the corner areas 21 (shown with a dashed line) with the auto body. However, this requires the mentioned additional control expense and optically produces a disadvantageous additional joint 18.

Consequently, the additional support 14 according to the invention can be displaced for the roof opening into the front position depicted in FIG. 5, in which the front roof part 7 is shortened and therefore requires less space in the vehicle longitudinal direction. This position is the movement position of roof 3 in which it can be inserted into body 4. Passage through the body outer surface 19 is shown in FIG. 12 viewed from the top. It is apparent that the lateral frame parts 16 can enter recess 9 free of collision just in front of edge 11 without edge 11 having to be movable. The recess 9 can therefore have minimal dimensions.

Nevertheless, the gap 20 shown in FIG. 12 between the front roof part 7 and the edge 11 can be closed by subsequent redeployment of the additional support 14, that is in one piece in the practical example, so that the cover 6 is stretched taut over surface 10 even in the stored position and spans at least almost the entire depth of recess 9. An optically disadvantageous gap 20 that is also connected with the hazard of break-in is therefore minimized. The corners 21 of the front roof area 7 can then be displaced by deployment of the additional support 14 to below the edge 11 in the side areas 11a.

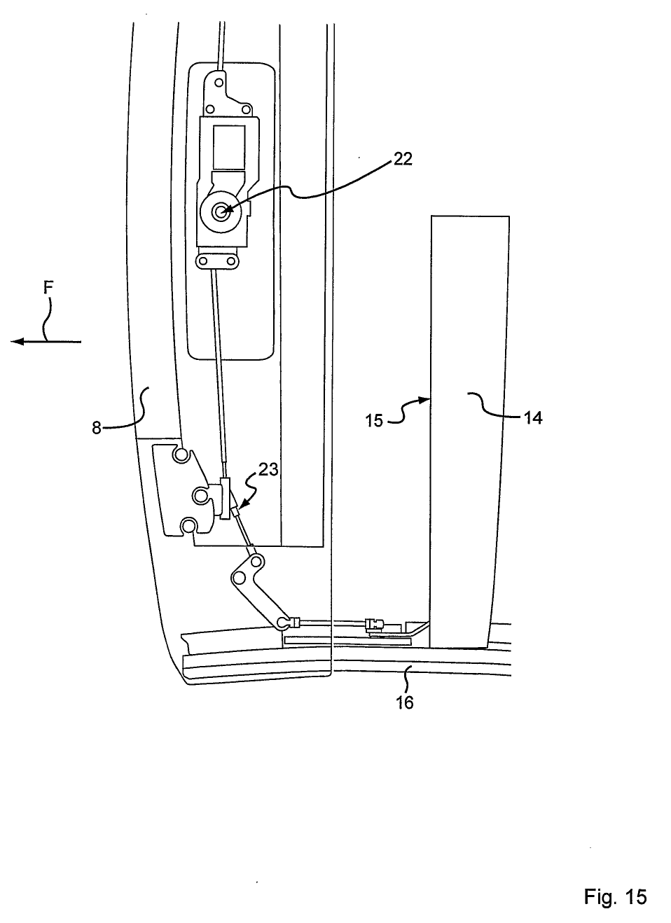

The additional support 14 can therefore be situated in its position maximally displaced to the rear and spanning cover 6, both in a closed and fully open roof 3, whereas it is displaced forward at least in the passage phase of roof area 7 through the outer surface 19. In order to configure the control for this as simply as possible, displacement of the additional support 14 is coupled with a closure 22 shown in FIGS. 14 and 15 that causes locking of roof 3 onto windshield frame 2. The coupling can be designed, for example, so that during manual or driven release of the lock (transition from FIG. 4 to FIG. 5), the additional support 14 is pulled forward in the direction of travel via a pull-push rod 23, springs, Bowden cables or similar design elements, remains in this position during the entire roof movement and, only when roof 3 is in the stored position (transition from FIG. 6 to FIG. 7), is it displaced rearward again by engaging in of closure 22 on auto body 4.

The displacement can be pure translation, for example in a slide, or it can overlap with a pivot movement, for example via a parallelogram. The additional support, as shown here, need not be in one piece either.

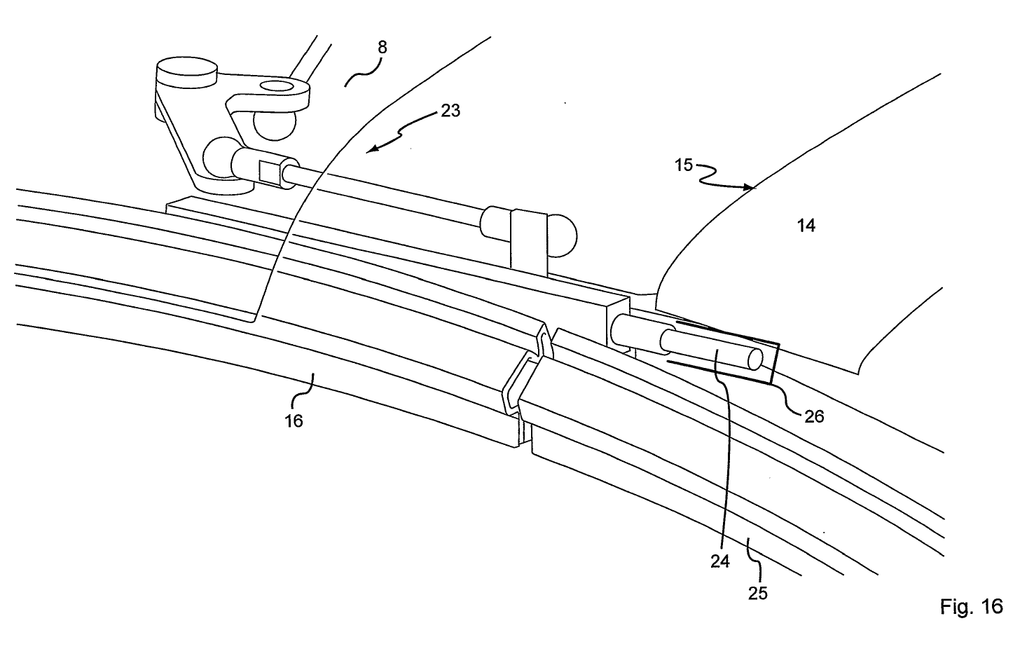

Additional locking of the first and second roof frame parts 16, 25 is possible via a locking element 24 that deploys rearward with the additional support and is shown in FIG. 16. The locking element 24 can engage in a sleeve 26 (FIG. 16) firmly connected to the second roof frame part 25.

The invention is usable for roof 3 to be moved manually, as well as semi- or fully automatically.

While the best modes for carrying out the invention have been described in detail, those familiar with the art to which this invention relates will recognize various alternative designs and embodiments for practicing the invention within the scope of the appended claims.

1. Cabriolet vehicle (1) with a roof (3) which at least in some areas has a flexible cover (6), which includes in its front roof area (7) a rigid end area (8), a so-called roof top, overlapped by a cover (6), in which the front roof area (7) can be stored in the same orientation as in the closed roof state in or partially above a body recess (9), which is bounded at least rearward by an edge (11) of auto body (4), characterized by the fact that the front roof area (7) is variable in length by at least one additional support (14) that supports roof area (6) from below, and can be displaced in the vehicle longitudinal direction.

2. Cabriolet vehicle (1) according to claim 1, characterized by the fact that the edge (11) adjacent to the body recess (9) in the open position of roof (3) is held from below at least in the outer vehicle transverse areas (11a) by the additional support (14) with the cover (6) overlapping it.

3. Cabriolet vehicle (1) according to claim 1, characterized by the fact that movement of the additional support (14) is controllable as a function of the corresponding movement state of roof (3).

4. Cabriolet vehicle (1) according to claim 1, characterized by the fact that the additional support (14) is controllable via a closure (22) that causes locking of roof (3) to a windshield frame (2).

5. Cabriolet vehicle (1) according to claim 1, characterized by the fact that the additional support (14) is deployed rearward opposite direction of travel (F) both in the closed and fully opened position of roof (3).

6. Cabriolet vehicle (1) according to claim 1, characterized by the fact that the additional support (14) is displaced forward during the opening or closing movement of roof (3) in direction of travel (F).

7. Cabriolet vehicle (1) according to claim 1, characterized by the fact that the additional support (14) extends across direction of travel (F).

8. Cabriolet vehicle (1) according to claim 1, characterized by the fact that the additional support (14) is designed in the fashion of a convertible top bow that supports the cover (6) from below over its entire width.

9. Cabriolet vehicle (1) according to claim 1, characterized by the fact that the additional support (14) includes an essentially rectangular surface in top view and with its front edge (15) lying across the direction of travel (F) and is connected almost flush to roof top (8) in the forward displaced position.

10. Cabriolet vehicle (1) according to claim 1, characterized by the fact that the edge (11) adjacent to the body recess (9) is at least in part of its area is the front edge (12) of a trunk lid (13).

11. Cabriolet vehicle (1) according to claim 1, characterized by the fact that the edge adjacent to the body recess is at least in part of its area the front edge of a transverse support of the body outside surface (19) arranged in front of a trunk lid (13).

12. Cabriolet vehicle (1) according to claim 1, characterized by the fact that locking of the first and second roof frame part (16; 25) can be produced by the displaceable additional support (14).
